(19) United States
(12) Patent Application Publication
(10) Pub. No.: US 2012/0226514 A1
(43) Pub. Date: Sep. 6, 2012

(54) Calendaring Tool Having Visual Clues to Address Conflicting Meeting Invitations

(75) Inventors: Kanisha Patel, Austin, TX (US); Audrey D. Romonosky, Austin, TX (US); Ronald Romonosky, Austin, TX (US); Cristi N. Ullmann, Austin, TX (US); Julissa Villarreal, Pflugerville, TX (US); Aruna Yedavilli, Austin, TX (US)

(73) Assignee: INTERNATIONAL BUSINESS MACHINES CORPORATION, Armonk, NY (US)

(21) Appl. No.: 13/037,855

(22) Filed: Mar. 1, 2011

(51) Int. Cl. G06Q 10/00

(52) U.S. Cl. 705/7.19

(57) ABSTRACT

Methods and systems of distinguishing conflicting appointments from one another may involve determining, for each of a plurality of conflicting appointments, a corresponding visual differentiator based on appointment detail information. The plurality of conflicting appointments and corresponding visual differentiators may be displayed in a calendar view, wherein the appointment detail information is excluded from the calendar view.

### BACKGROUND

Embodiments of the present invention generally relate to appointment management. More particularly, embodiments relate to electronic calendaring tools that have visual clues to address conflicting appointments.

Electronic calendars can be used with both fixed and mobile computing platforms, and may be helpful in managing various meetings. Conventional calendaring tools, however, may display multiple meetings in views that do not provide sufficient information for the user to determine whether to attend, particularly when there are meeting conflicts.

### BRIEF SUMMARY

Embodiments may provide for a computer implemented method in which a visual differentiator is determined for each of a plurality of conflicting appointments based on appointment detail information. The plurality of conflicting appointments and corresponding visual differentiators may be displayed in a calendar view, wherein the appointment detail information is excluded from the calendar view and the visual differentiators distinguish the plurality of conflicting appointments from one another.

Embodiments may also include a computer program product including a computer readable storage medium and computer usable code stored on the computer readable storage medium. If executed by a processor, the computer usable code can cause a computer to determine, for each of a plurality of conflicting appointments, a corresponding visual differentiator based on appointment detail information. The computer usable code may also display the plurality of conflicting appointments and corresponding visual differentiators in the calendar view, and exclude the appointment detail information from the calendar view.

Other embodiments can involve a computer implemented method in which appointment detail information associated with each of a plurality of appointments is provided. The appointment detail information may include at least one of a work item associated with a user, an attendance requirement of the user, an acceptance by the user, a delegation to the user, and a predefined keyword match. The method may also involve conducting evaluations of each appointment to determine whether a conflict exists between the plurality of appointments, where each determined appointment conflict is based at least in part on the appointment detail information associated with a respective one of the plurality of appointments. In addition, visual differentiators may be generated for each appointment conflict in a calendar view. The visual differentiators for each appointment conflict can be displayed in a calendar view, wherein the appointment detail information is excluded from the calendar view.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is a block diagram of an example of a calendar view according to an embodiment;

FIGS. 2A and 2B are block diagrams of examples of appointment detail views according to an embodiment;

FIG. 3 is a block diagram of an example of a work item list according to an embodiment;

FIG. 4 is a flowchart of an example of a method of distinguishing conflicting appointments from one another according to an embodiment;

FIG. 5 is a block diagram of an example of a computing architecture according to an embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

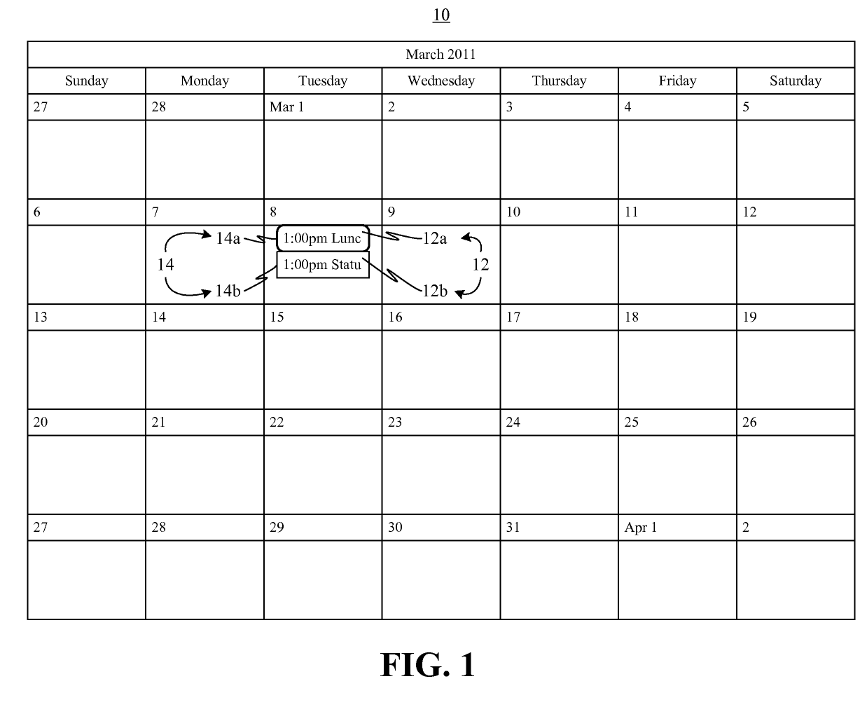

Referring now to FIG. 1, a calendar view 10 of a calendaring tool is shown in which a plurality of conflicting appointments 12 (12a-12b) are displayed concurrently. In the illustrated example, the calendar view 10 shows the month of March and the appointments 12 are both scheduled to begin at 1:00pm on the same day. Due to the limited amount of available screen space, however, only the starting time and the first few characters of the subject of each appointment 12 are shown (although a mouse-over action could reveal the full line of text). Even though a month is shown, the calendar view 10 could alternatively show a different period of time (e.g., week, day), in which the ability to view appointment details is also limited. In order to prevent a user of the calendar view 10 from experiencing difficulty in deciding which appointment 12 to attend, the illustrated approach also generates and displays a plurality of visual differentiators 14 (14a-14b) corresponding to the plurality of conflicting appointments 12, wherein the visual differentiators 14 distinguish the conflicting appointments 12 from one another and may provide clues to the user. As will be discussed in greater detail, the visual differentiators 14 may be automatically generated by the calendaring tool based on evaluations of appointment detail information not visible in the calendar view 10, and can therefore enable one or more users of the calendar view 10 to make rapid and informed decisions as to which appointment 12 to accept and/or attend.

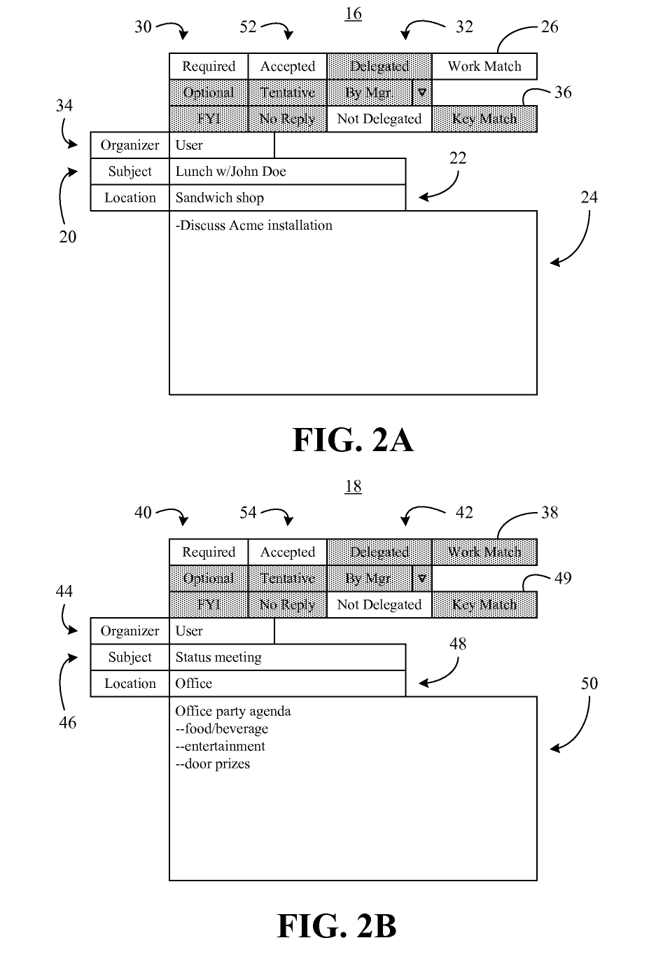

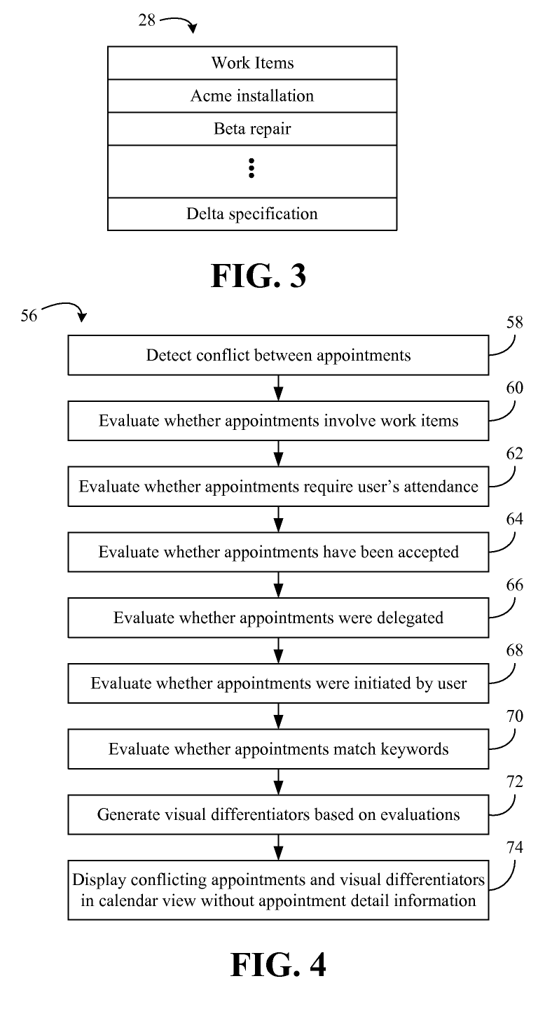

With continuing reference to FIGS. 1-3, examples of appointment detail views 16, 18, for the first and second conflicting appointments 12a, 12b, are shown, respectively. Thus, the appointment detail view 16 might replace the calendar view 10 on the device display if the first conflicting appointment 12a is selected (e.g., by single click, double click, voice command, etc.) from the calendar view 10, whereas the appointment detail view 18 may replace the calendar view 10 on the device display if the second conflicting appointment 12b is selected from the calendar view 10.

Generally, the appointment detail view 16 may include appointment detail information associated with the appointment 12a that can be useful in automatically generating the visual differentiator 14a. For example, the illustrated appointment detail view 16 includes a “work match” button/indicator 26 that indicates whether the appointment 12a involves a work item associated with the user. The work match indicator 26 could be selected by the user and/or automatically selected by the calendaring tool based on a comparison between the information in the appointment detail view 16 and a work items list 28. For example, the work items list 28 could contain various projects (e.g., “Acme installation”, “Beta repair”, “Delta specification”), wherein the list 28 may be populated by the user and/or other entity (e.g., manager, supervisor, work assignment system). Simply put, an evaluation may be conducted as to whether the work match indicator 26 indicates that the appointment 12a involves a work item associated with the user.

The illustrated appointment detail view 16 for the first conflicting appointment 12a also includes an attendance button/indicator 30 that indicates whether the appointment 12a requires the user's attendance. In the illustrated example, the attendance indicator 30 shows that “required” state is active, whereas the “optional” and “FYI” (for your information) states are inactive. The attendance indicator 30 might be selected by the initiator/organizer of the appointment, or automatically selected by the calendaring tool. For example, the illustrated approach automatically selects the required state because the user is the organizer of the appointment 12a. Thus, an evaluation may be conducted of the attendance indicator (and/or underlying data) 30 as to whether the appointment 12a requires the user's attendance.

Moreover, the appointment detail view 16 for the first conflicting appointment 12a may include an acceptance button/indicator 52 that indicates whether the appointment 12a has been accepted by the user. In the illustrated example, the acceptance indicator 52 shows that the “accepted state” is active, whereas the “tentative” (i.e., user has tentatively accepted) and “no reply” (i.e., user has not replied) states are inactive. The acceptance indicator 52 may be automatically selected by the calendaring tool based on the user's actions upon receiving an invitation to the appointment 12a or, as in the case shown, upon initiating the appointment 12a. Thus, an evaluation can be conducted of the acceptance indicator 52 as to whether the appointment 12a has been accepted by the user.

Other features of the appointment detail view 16 can include a delegation button/indicator 32 that indicates whether the appointment 12a was delegated to the user by another individual. For example, someone in the user's management chain or other entity might have requested that the user hold, conduct and/or organize the appointment 12a on the other party's behalf. In the illustrated example, the “not delegated” state is active because the appointment 12a was not delegated. The “delegated” and “by mgr.” (which enables a drop down view of the possible delegating parties) states, on the other hand, are inactive. An evaluation may therefore be conducted as to whether the delegation indicator 32 indicates that the appointment 12a was delegated to the user and, if so, by whom.

The appointment detail view 16 also includes an organizer field 34 that indicates who initiated the appointment 12a. The organizer field 34 may be manually populated by the user or automatically populated by the calendaring tool, wherein a determination may be made as to whether the user or other individual (e.g., user's manager/supervisor) initiated the appointment 12a. Other features of the appointment detail view 16 include, but are not limited to, a subject field 20 that contains the full text of the subject of the appointment 12a, a location field 22 that contains the location of the appointment and a notes field 24 that contains comments and/or notes (e.g., agenda) regarding the appointment 12a. Evaluations could be conducted on each of these fields 20, 22, 24 as to whether the appointment 12a matches a predefined keyword, wherein a key match indicator 36 may be used to indicate that a match exists. For example, the user can generate a customized profile containing various tags, alphanumeric strings, terms, etc. to search for when evaluating the appointment detail information.

Similarly, the appointment detail view 18 associated with the second conflicting appointment 12b may include a work match indicator 38, attendance indicator 40, acceptance indicator 54, delegation indicator 42, key match indicator 49, organizer field 44, subject field 46, location field 48, and notes field 50, wherein each of these aspects of the appointment detail information can be evaluated comparatively to the appointment detail information associated with the first conflicting appointment 12a in generating the visual differentiators 14. For example, the first conflicting appointment 12a is encircled by a bold border in the calendar view 10, whereas the second conflicting appointment 12b is encircled by a normal (e.g., non-bold) border in the calendar view 10 because the first conflicting appointment 12a matches an item on the work items list 28 (i.e., “Acme installation”) and the second conflicting appointment 12b does not. Simply put, because the other evaluation parameters are the same between the conflicting appointments 12 in the illustrated example, the visual differentiator 14a is enhanced relative to the visual differentiator 14b on the basis of the work item match. The various evaluation parameters could also be weighted based on user preference or other metric, to account for instances where different parameters favor different conflicting appointments.

The visual differentiators 14 could also distinguish the conflicting appointments 12 from one another using other techniques such as color distinctions (e.g., red light, yellow light, green light), font (e.g., italics, underline, bold) distinctions, and so on. Thus, the user may determine solely from the calendar view 10 that he or she should attend the first conflicting appointment 12a even though the limited information available in the calendar view 10 (e.g., “Lunc” and “Statu”) might have suggested otherwise without the visual differentiators 14. Moreover, the illustrated approach may save time and reduce inconvenience to the user by eliminating the need to open the appointment detail views 16, 18 of the appointments 12 before making a decision. The appointment detail information may also include other information, such as appointment attendee/invitee information, customer participation information, etc., that can also be evaluated for generation of the visual differentiators 14. In addition, the appointment detail information may be stored and/or maintained in a database such as a relational database that can be queried and/or updated as appropriate.

Turning now to FIG. 4, a method 56 of distinguishing conflicting appointments from one another is shown. The method 56 could be implemented in a calendaring tool running on a client device, a server, other computing platform, or any combination thereof. Illustrated processing block 58 provides for detecting a conflict between two or more appointments, wherein the appointments may be accepted, tentative, pending, or any combination thereof. An evaluation can be conducted at block 60 as to whether appointment detail information associated with one or more of the conflicting appointments indicates that a conflicting appointment involves a work item. As already noted, the work item evaluation could include a query of a work item list prepared by the user or other party/system component.

Illustrated block 62 provides for conducting an evaluation as to whether appointment detail information indicates that one or more conflicting appointments has been accepted, and illustrated block 64 provides for conducting an evaluation as to whether the appointment detail information indicates that one or more conflicting appointments has been accepted. An evaluation may also be made at block 66 as to whether the appointment detail information indicates that one or more conflicting appointments was delegated to the user, and an evaluation can be made at block 68 as to whether the appointment detail information indicates that one or more conflicting appointments was initiated by the user. In addition, illustrated block 70 provides for conducting an evaluation as to whether appointment detail information indicates that the one or more conflicting appointments match a predefined keyword. A plurality of visual differentiators may be generated at block 72 based at least in part on the above-described evaluations, wherein the visual differentiators distinguish the conflicting appointments from one another. The conflicting appointments and the visual differentiators can be displayed in a calendar view at block 74 without the appointment detail information, wherein the visual differentiators may distinguish the conflicting appointments from one another on a wide variety of bases such as a color basis, a font basis, a border basis, an icon basis (e.g., star, rectangle, circle), and so on.

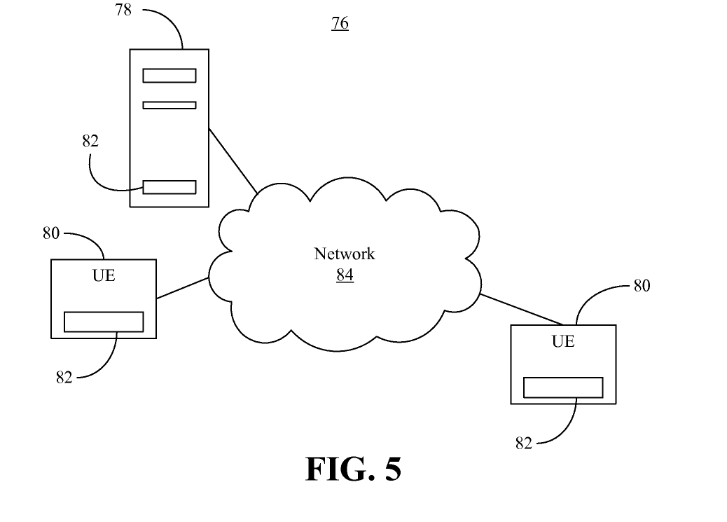

FIG. 5 shows a networking architecture 76 in which a server 78 and/or user equipment (UE) devices 80 include logic 82 to determine, for each of a plurality of conflicting appointments, a corresponding visual differentiator based on appointment detail information. The logic 82 can also display the plurality of conflicting appointments and corresponding visual differentiators in a calendar view, and exclude the appointment detail information from the calendar view, as already discussed. In the illustrated example, the UE devices 80, which may include calendaring tool capability, may also include a personal computer (PC), notebook computer, personal digital assistant (PDA), wireless smartphone, or other device having access to the server 78, via a network 84.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computer implemented method comprising:
providing appointment detail information associated with each of a plurality of appointments, the appointment detail information including at least one of,
a work item associated with a user;
an attendance requirement of the user;
an acceptance by the user;
a delegation to the user; and
a predefined keyword match;
conducting evaluations of each appointment to determine whether a conflict exists between the plurality of appointments, each determined appointment conflict being based at least in part on the appointment detail information associated with a respective one of the plurality of appointments;
generating visual differentiators for each appointment conflict based at least in part on the evaluations;
displaying the visual differentiators for each appointment conflict in a calendar view; and
excluding the appointment detail information from the calendar view.

2. The method of claim 1, wherein the visual differentiators distinguish conflicting appointments from one another on at least one of a color basis, a font basis and a border basis.

3. A computer implemented method comprising:
determining, for each of a plurality of conflicting appointments, a corresponding visual differentiator based on appointment detail information;
displaying the plurality of conflicting appointments and corresponding visual differentiators in a calendar view; and
excluding the appointment detail information from the calendar view.

4. The method of claim 3, wherein determining one or more of the visual differentiators includes:
conducting an evaluation as to whether appointment detail information associated with a conflicting appointment indicates that the conflicting appointment involves a work item associated with a user; and
generating the visual differentiator based at least in part on the evaluation.

5. The method of claim 3, wherein determining one or more of the visual differentiators includes:
conducting an evaluation as to whether appointment detail information associated with a conflicting appointment indicates that the conflicting appointment requires a user's attendance; and
generating the visual differentiator based at least in part on the evaluation.

6. The method of claim 3, wherein determining one or more of the visual differentiators includes:
conducting an evaluation as to whether appointment detail information associated with a conflicting appointment indicates that the conflicting appointment has been accepted by a user; and
generating the visual differentiator based at least in part on the evaluation.

7. The method of claim 3, wherein determining one or more of the visual differentiators includes:
conducting an evaluation as to whether appointment detail information associated with a conflicting appointment indicates that the conflicting appointment was delegated to a user; and
generating the visual differentiator based at least in part on the evaluation.

8. The method of claim 7, wherein the evaluation includes an evaluation as to whether the conflicting appointment was delegated by a manager of the user.

9. The method of claim 3, wherein determining one or more of the visual differentiators includes:
conducting an evaluation as to whether appointment detail information associated with a conflicting appointment indicates that the appointment was initiated by a user; and
generating the visual differentiator based at least in part on the evaluation.

10. The method of claim 3, wherein determining one or more of the visual differentiators includes:
conducting an evaluation as to whether appointment detail information associated with a conflicting appointment indicates that the conflicting appointment matches a predefined keyword; and
generating the visual differentiator based at least in part on the evaluation.

11. The method of claim 3, wherein the visual differentiators distinguish the plurality of conflicting appointments from one another on at least one of a color basis, a font basis, an icon basis and a border basis.

12. A computer program product comprising:
a computer readable storage medium; and
computer usable code stored on the computer readable storage medium, where, if executed by a processor, the computer usable code causes a computer to:
determine, for each of a plurality of conflicting appointments, a corresponding visual differentiator based on appointment detail information;
display the plurality of conflicting appointments and corresponding visual differentiators in a calendar view; and
exclude the appointment detail information from the calendar view.

13. The computer program product of claim 12, wherein the computer usable code, if executed, causes a computer to:
conduct an evaluation as to whether appointment detail information associated with a conflicting appointment indicates that the conflicting appointment involves a work item associated with a user; and
generate a visual differentiator based at least in part on the comparison.

14. The computer program product of claim 12, wherein the computer usable code, if executed, causes a computer to:
conduct an evaluation as to whether appointment detail information associated with a conflicting appointment indicates that the conflicting appointment requires a user's attendance; and
generate a visual differentiator based at least in part on the evaluation.

15. The computer program product of claim 12, wherein the computer usable code, if executed, causes a computer to:
conduct an evaluation as to whether appointment detail information associated with a conflicting appointment indicates that the conflicting appointment has been accepted by a user; and
generate a visual differentiator based at least in part on the evaluation.

16. The computer program product of claim 12, wherein the computer usable code, if executed, causes a computer to:
conduct an evaluation as to whether appointment detail information associated with a conflicting appointment indicates that the conflicting appointment was delegated to a user; and
generate a visual differentiator based at least in part on the evaluation.

17. The computer program product of claim 16, wherein the evaluation is to include an evaluation as to whether the conflicting appointment was delegated by a manager of the user.

18. The computer program product of claim 12, wherein the computer usable code, if executed, causes a computer to:
conduct an evaluation as to whether appointment detail information associated with a conflicting appointment indicates that the appointment was initiated by a user; and
generating a visual differentiator based at least in part on the evaluation.

19. The computer program product of claim 12, wherein the computer usable code, if executed, causes a computer to:
conduct an evaluation as to whether appointment detail information associated with a conflicting appointment indicates that the conflicting appointment matches a predefined keyword; and
generate a visual differentiator based at least in part on the evaluation.

20. The computer program product of claim 12, wherein the visual differentiators are to distinguish the plurality of conflicting appointments from one another on at least one of a color basis, a font basis, an icon basis and a border basis.
